(19) United States
(12) Patent Application Publication
(10) Pub. No.: US 2009/0182999 A1
(43) Pub. Date: Jul. 16, 2009

(54) Method And System For Security Certificate Properties For Protocol Exchange

(76) Inventor: Scott Krig, Santa Clara, CA (US)

Correspondence Address: MCANDREWS HELD & MALLOY, LTD, 500 WEST MADISON STREET, SUITE 3400, CHICAGO, IL, 60661, US

(21) Appl. No.: 12/195,275

(22) Filed: Aug. 20, 2008

Related U.S. Application Data
(60) Provisional application No. 61/021,509, filed on Jan. 16, 2008.
(60) Provisional application No. 61/077,310, filed on Jul. 1, 2008.

(51) Int. Cl. H04L 9/00; G06F 13/42

(52) U.S. Cl. 713/156; 710/105

(57) ABSTRACT

An extension of the Media Transfer Protocol (MTP) may enable marking and/or identifying objects comprising public keys and/or security certificates with object properties. The object properties may identify the objects and/or specify a source of the objects. The objects and object properties may be stored and/or communicated to and/or from a device that supports MTP communications. The communication may occur during initiation of communication between the devices and/or in a response to a request for information. For example, MTP operations GetObjectPropDesc or GetObjectPropValue and corresponding responses ObjectPropDesc dataset or a current value may be utilized. A public key and/or security certificate object may be marked with regard to identity and/or source and the marked information may be communicated via MTP. In this regard, MTP communication may be secured based on one or more MTP objects and/or object properties.

### CROSS-REFERENCE TO RELATED APPLICATIONS/INCORPORATION BY REFERENCE

This application makes reference to, claims priority to, and claims the benefit of U.S. Provisional Application Ser. No. 61/021,509, filed on Jan. 16, 2008, entitled “METHOD AND SYSTEM FOR SECURITY CERTIFICATE PROPERTIES FOR PROTOCOL EXCHANGE,” which is hereby incorporated herein by reference in its entirety.

This application makes reference to, claims priority to, and claims the benefit of U.S. Provisional Application Ser. No. 61/077,310, filed on Jul. 1, 2008, entitled “METHOD AND SYSTEM FOR SECURITY CERTIFICATE PROPERTIES FOR PROTOCOL EXCHANGE,” which is hereby incorporated herein by reference in its entirety.

### FIELD OF THE INVENTION

Certain embodiments of the invention relate to multimedia communication. More specifically, certain embodiments of the invention relate to a method and system for security certificate properties for protocol exchange.

### BACKGROUND OF THE INVENTION

The media transfer protocol (MTP) is an extension of the industry standard picture transfer protocol (PTP). The media transfer protocol was created as an extension to the picture transfer protocol specifically for media devices and includes various provisions for digital rights management (DRM).

Digital rights management (DRM) and electronic license management technologies may be utilized for home video, music, consumer and enterprise software markets. Motion picture studios, cable and satellite TV operators, consumer electronics companies and personal computer manufacturers use DRM technologies to prevent the unauthorized duplication, reception or use of copyrighted video materials.

PIMA 15740:2000 provides a common communication mechanism for exchanging images with and between digital still photography devices (DSPDs). This includes communication between digital still photography devices and host computers, printers, other digital still devices, telecommunications kiosks, and image storage and display devices. This standard presents a protocol that is intended to be transport and platform independent. The purpose of this intent is to enable standard behavior by allowing implementation of the protocol in a variety of standard transports. Exemplary transports include USB (Universal Serial Bus), IEEE 1394, and IrDA (Infrared Data Association). This standard specifies the following:

Behavior requirements for DSPDs include: baseline features a device needs to support to provide interoperability over conforming transports; functional requirements needed by a transport to enable the creation of a transport-dependent implementation specification that conforms to this standard; and a high-level protocol for communicating with and between DSPDs consisting of operation, data, and response phases.

Further limitations and disadvantages of conventional and traditional approaches will become apparent to one of skill in the art, through comparison of such systems with the present invention as set forth in the remainder of the present application with reference to the drawings.

### BRIEF SUMMARY OF THE INVENTION

A system and/or method for security certificate properties for protocol exchange, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a block diagram of exemplary media devices enabled to modify and/or communicate MTP object properties via an extension of the MTP standard, in accordance with an embodiment of the invention.

FIG. 2 is a flow chart illustrating exemplary steps for downloading public key objects, security certificate objects and corresponding object properties utilizing MTP operations, in accordance with an embodiment of the invention.

FIG. 3 is a flow chart illustrating exemplary steps for utilizing MTP and a shared public key for encryption and decryption of an object, in accordance with an embodiment of the invention.

FIG. 4 is a flow chart illustrating exemplary steps for FIG. 4 is a flow chart illustrating exemplary steps utilizing MTP and a public key, private key and security certificate for securing communication, in accordance with an embodiment of the invention.

### DETAILED DESCRIPTION OF THE INVENTION

Aspects of the invention may be found in a method and system for security certificate properties for protocol exchange. In this regard, an extension of the Media Transfer Protocol (MTP) may enable marking and/or identifying one or more objects that may enable securing of MTP communications. Information that marks and/or identifies the objects may be stored within one or more devices. In addition, the objects and/or the specified information may be communicated to and/or from a device that supports MTP communications. In this regard, one or more of the objects may comprise one or more of security certificates or public keys. The information about the objects may identify an object as a security certificate or public key and/or may indicate a source of the security certificate and/or the public key by specifying the information within one or more MTP object properties.

In various embodiments of the invention, a device may communicate a public key and/or security certificate object and/or corresponding object properties to another device during initiation of communication between the devices. In addition, the object and/or corresponding object properties may be communicated or specified in a response to a request for information. For example, one or more MTP operations such as GetObjectPropDesc or GetObjectPropValue may be utilized to request the object properties. Corresponding responses may comprise an ObjectPropDesc dataset or an object property current value from the ObjectPropDesc dataset, respectively. In this manner, the public key and/or security certificate object may be marked with regard to identity and/or source of the object and the marked information may be communicated via MTP. In this regard, MTP communication may be secured based on one or more MTP objects and/or object properties.

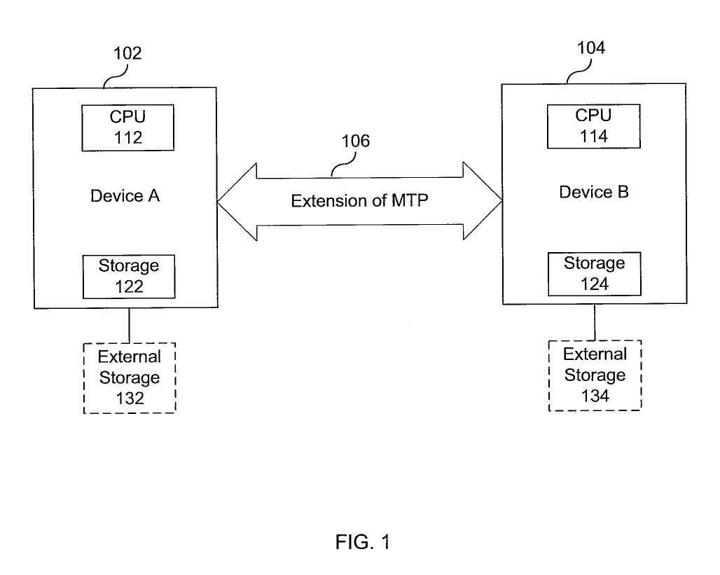

FIG. 1 is a block diagram of exemplary media devices enabled to modify and/or communicate MTP object properties via an extension of the MTP standard, in accordance with an embodiment of the invention. Referring to FIG. 1 there is shown an extension of the media transfer protocol (MTP) 106 that may facilitate secure communication between a device 102 and a device 104. The devices 102 and 104 may comprise processors 112 and 114 respectively, internal storage 122 and 124 respectively and/or external storage 132 and 134 respectively.

The device 102 may comprise suitable logic, circuitry and/or code that may enable transfer of information to and/or from the device 104 via MTP and an extension of the MTP 106. The device 102 may be a media device that may comprise suitable processing 112 and storage capacity 122 and/or 132 for consuming and/or producing media objects. Moreover, the device 102 may be enabled to function as an initiator device with regard to MTP operations. The device 102 may be for example, a host computer or PC. In various embodiments of the invention, the device 102 may enable marking MTP objects with one or more object properties and/or communicating object property information to and/or from the device 104.

The device 104 may comprise suitable logic, circuitry, and/or code that may enable transfer of information to and/or from the device 104 via MTP and an extension of the MTP 106. The device 104 may be a media device that may comprise suitable processing 114 and storage capacity 124 and/or 134 for consuming and/or producing media objects. Moreover, the device 104 may be, for example, enabled to function as a responder device with regard to MTP operations. For example, the device 104 may be a still or video digital camera, a portable media player, a cell phone or PC. In various embodiments of the invention, the device 104 may enable marking MTP objects with one or more object properties and/or communicating object property information with the device 102.

The extension of the MTP 106 may comprise modified specifications within the MTP architecture that may enable marking MTP objects, for example, storing information about MTP objects as MTP object properties and/or communicating the MTP properties between the device 102 and device 104. MTP objects may comprise, for example, data, corresponding metadata and/or object reference data wherein the data may comprise audio and/or video files, text files, programs, scheduled events or contact information for example. In addition, the data portion of an object may comprise information for securing MTP communication, for example, by utilizing a public key and/or security certificate. In this regard, the extension to the MTP 106 may comprise one or more object properties conveying information about the data. For example, an object comprising a public key may have an object property that identifies the data as a public key and/or an object property that inidcates the source of the publice key. Similarly, an object comprising a security certificate may have an object property that identifies the object's data as a security certificate and/or an object property that inidcates the source of the security certificate.

In various embodiments of the invention, one or more object properties may be utilized to mark and/or identify an object comprising a public key. The PublicKey property shown in FIG. 1 may identify an object as an object comprising a value of the public key. In addition, the PublicKey property may comprise a string value. The invention is not limited to any specific string for the PublicKey property and may utilize any suitable string. Exemplary PublicKey property strings may comprise useful identifying information about the public key holder such as a name or email address for example.

TABLE 1
PublicKey Property

| | | Size | | |
|---|---|---|---|---|
| Field name | Field order | (bytes) | Datatype | Value |
| PropertyCode | 1 | 2 | UINT16 | 0xDXXX |
| Datatype | 2 | 2 | UINT16 | 0xFFFF (STRING) |
| Get/Set | 3 | 1 | UINT8 | 0x01 (GET/SET) |
| DefaultValue | 4 | | | 0x00 (Null String) |
| GroupCode | 5 | 4 | UINT32 | Device-defined |
| FormFlag | 6 | 1 | UINT8 | 0x00 None |

In addition, a PublicKeySource property shown in Table 2, may be utilized to mark an object that comprises a public key to identify a source or location of an MTP endpoint that delivered the public key. The invention is not limited to any specific source identifying information string and may utilize any suitable string. Exemplary strings may comprise an application name, GUID, URL, MAC address, IP address, phone number, street address, email address, program name and/or build date.

TABLE 2
PublicKeySource Property

| | | Size | | |
|---|---|---|---|---|
| Field name | Field order | (bytes) | Datatype | Value |
| PropertyCode | 1 | 2 | UINT16 | 0xDXXX |
| Datatype | 2 | 2 | UINT16 | 0xFFFF (STRING) |
| Get/Set | 3 | 1 | UINT8 | 0x01 (GET/SET) |
| DefaultValue | 4 | | | 0x00 (Null String) |
| GroupCode | 5 | 4 | UINT32 | Device-defined |
| FormFlag | 6 | 1 | UINT8 | 0x00 None |

In accordance with an embodiment of the invention, SecurityCertificate object property shown in Table 3 may be utilized to mark and/or identify an object that may comprise a security certificate. The type of security certificate may be specified in a string field. The invention is not limited to any specific type of security certificate. Notwithstanding, exemplary security certificates may be X.509 or XKMS. A security certificate within the object may correspond to the SecurityCertificate property

TABLE 3
SecurityCertificate Property

| | | Size | | |
|---|---|---|---|---|
| Field name | Field order | (bytes) | Datatype | Value |
| PropertyCode | 1 | 2 | UINT16 | 0xDXXX |
| Datatype | 2 | 2 | UINT16 | 0xFFFF (STRING) |
| Get/Set | 3 | 1 | UINT8 | 0x01 (GET/SET) |
| DefaultValue | 4 | | | 0x00 (Null String) |
| GroupCode | 5 | 4 | UINT32 | Device-defined |
| FormFlag | 6 | 1 | UINT8 | 0x00 None |

An MTP SecurityCertificatesource object property shown in Table 4, may be utilized to mark and/or identify an object which may comprise a security certificate to identify the source or location of an MTP endpoint that delivered the security certificate. The invention is not limited to any specific string for identifying a source of a security certificate and may utilize any suitable string. Exemplary source information may comprise a GUID, URL, MAC address, IP address, phone number, street address, email address, program name and/or build date.

TABLE 4
SecurityCertificateSource Property

| | | Size | | |
|---|---|---|---|---|
| Field name | Field order | (bytes) | Datatype | Value |
| PropertyCode | 1 | 2 | UINT16 | 0xDXXX |
| Datatype | 2 | 2 | UINT16 | 0xFFFF (STRING) |
| Get/Set | 3 | 1 | UINT8 | 0x01 (GET/SET) |
| DefaultValue | 4 | | | 0x00 (Null String) |
| GroupCode | 5 | 4 | UINT32 | Device-defined |
| FormFlag | 6 | 1 | UINT8 | 0x00 None |

In operation, device 102 shown in FIG. 1 may be a host computer that may download secure media content to a device 104 that may be for example a handheld media device. The devices 102 and 104 may support the MTP extension 106 that may enable exchange of public keys and security certificates as well as object properties that may mark and/or identify public key and/or security certificate objects. In this regard, MTP operations may be utilized to enable secure communications.

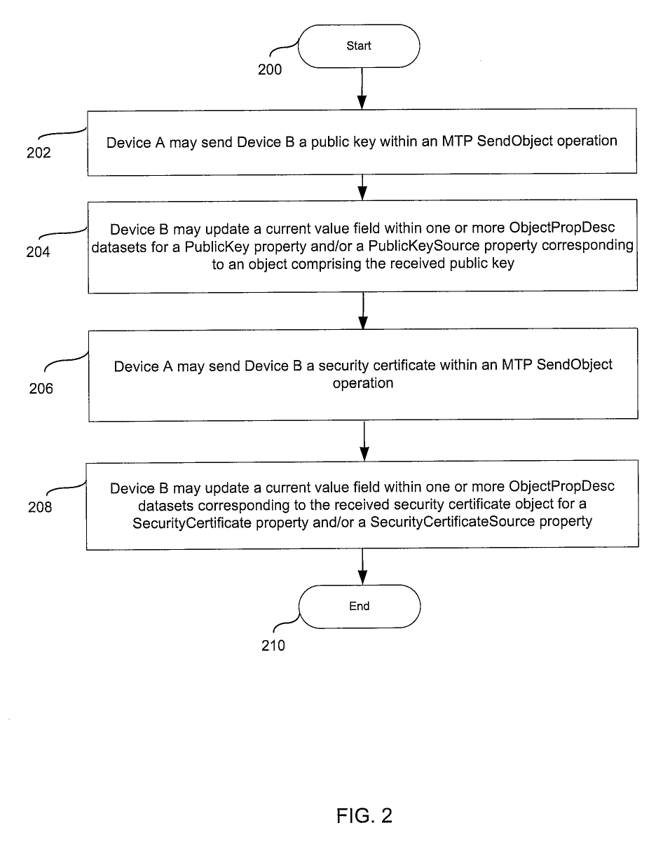

FIG. 2 is a flow chart illustrating exemplary steps for downloading public key objects, security certificate objects and corresponding object properties utilizing MTP operations, in accordance with an embodiment of the invention. Referring to FIG. 2, after start step 200, in step 202, device A 102 may send Device B 104 a public key within an MTP SendObject operation. In step 204, device B 104 may update a current value field within one or more ObjectPropDesc datasets for a PublicKey property and/or a PublicKeySource property corresponding to an object comprising the received public key. In step 206, device A 102 may send Device B 104 a security certificate within an MTP SendObject operation. In step 208, device B 104 may update a current value field within one or more ObjectPropDesc datasets corresponding to the received security certificate object for a SecurityCertificate property and/or a SecurityCertificateSource property. Step 210 may be an end of exemplary steps.

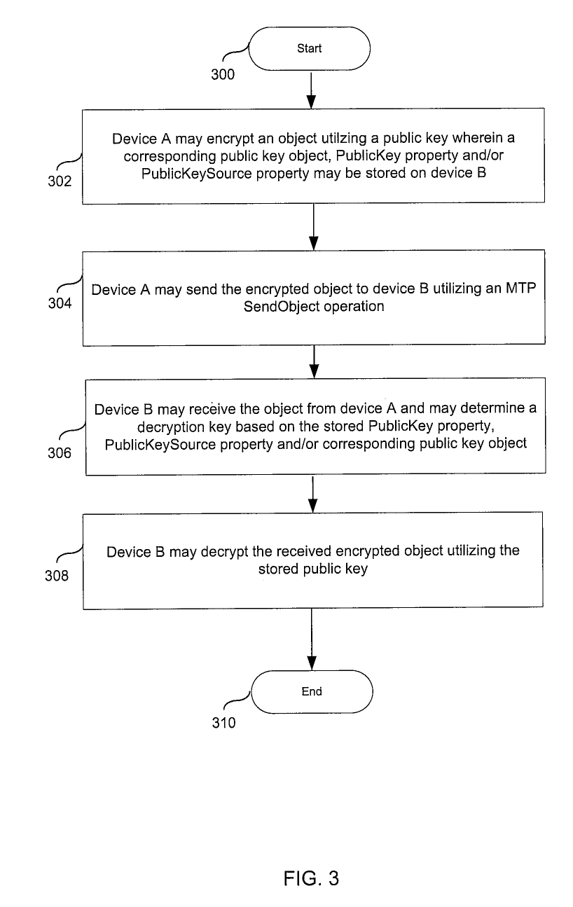

FIG. 3 is a flow chart illustrating exemplary steps for utilizing MTP and a shared public key for encryption and decryption of an object, in accordance with an embodiment of the invention. Referring to FIG. 3, after start step 300, in step 302, device A 102 may encrypt an object utilzing a public key wherein a corresponding public key object, PublicKey property and/or PublicKeySource property may be stored on device B. In step 304, the device A 102 may send the encrypted object to device B 104 utilizing an MTP SendObject operation. In step 306, the device B 104 may receive the object from device A 102 and may determine a decryption key based on the stored PublicKey property, PublicKeySource property and/or corresponding public key object. In step 308, the device B 104 may decrypt the received encrypted object utilizing the stored public key. Step 310 may be the end of exemplary steps.

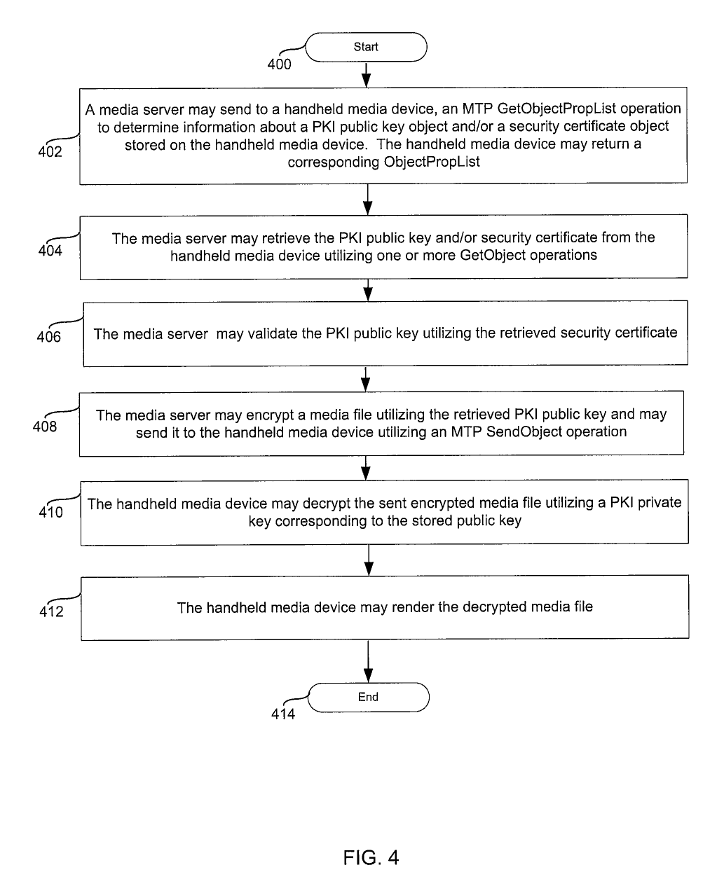

FIG. 4 is a flow chart illustrating exemplary steps utilizing MTP and a public key, private key and security certificate for securing communication, in accordance with an embodiment of the invention. Referring to FIG. 4, after start step 400, in step 402, a media server such as device 102 may send to a handheld media device such as device 104, an MTP GetObjectPropList operation to determine information about a PKI public key object and/or a security certificate object stored on the handheld media device 104. The handheld media device 104 may return a corresponding ObjectPropList. In step 404, the media server 102 may retrieve the PKI public key and/or security certificate from the handheld media device 104 utilizing one or more GetObject operations. In step 406, the media server 102 may validate the PKI public key utilizing the retrieved security certificate. In step 408, the media server 102 may encrypt a media file utilizing the retrieved PKI public key and may send it to the handheld media device 104 utilizing an MTP SendObject operation. In step 410, the handheld media device 104 may decrypt the sent encrypted media file utilizing a PKI private key corresponding to the stored public key. In step 412, the handheld media device 104 may render the decrypted media file. Subsequent to step 412, step 414 may be the end of exemplary steps.

A method and system for marking one or more MTP objects via object marking properties and exchanging object marking properties between devices 102 and 104 may be specified in one or more extensions of media transfer protocol (MTP) 106. The device B 104 may communicate current object property values to another device A 102 upon initiation of communication or in response to an operation request such as GetObjectPropDesc and/or GetObjectPropValue for a specified object. A corresponding response from device B 104 may comprise an MTP ObjectPropDesc dataset and/or a current value from the DevicePropDesc dataset. Object marking properties may comprise, for example, PublicKey, PublicKeySource, SecurityCertificate and SecurityCertificateSource for example.

In an embodiment of the invention, an extension of media transfer protocol (MTP) 106 may enable securing exchange of multimedia information between two or more devices, for example, devices 102 and 104 that may communicate via MTP. In this regard, one or more keys and/or security certificates may be communicated between the two devices 102 and 104 utilizing one or more objects specified by an extension of the MTP 106. The one or more objects may be identified as comprising one or more security certificates utilizing a corresponding MTP object property. In addition, a corresponding MTP object property may be utilized to indicate a source of the one or more security certificates. Furthermore, the one or more objects may be identified as comprising one or more keys utilizing a corresponding MTP object property. Accordingly, a corresponding MTP object property may be utilized to indicate a source of the one or more keys.

In various embodiments of the invention, a device 104 may communicate one or more public key objects and/or one or more security certificate objects and/or corresponding object properties to another device 102 during initiation of communication between the devices. In addition, the one or more objects and/or corresponding object properties may be communicated or specified in a response to a request for information. For example, one or more MTP operations such as GetObjectPropDesc or GetObjectPropValue may be utilized to request the object properties. Corresponding responses may comprise an ObjectPropDesc dataset or an object property current value from the ObjectPropDesc dataset, respectively. In this manner, the public key and/or security certificate object may be marked with regard to identity and/or source of the object and the marked information may be communicated via MTP. In this regard, MTP communication may be secured based on one or more MTP objects and/or object properties.

Another embodiment of the invention may provide a machine and/or computer readable storage and/or medium, having stored thereon, a machine code and/or a computer program having at least one code section executable by a machine and/or a computer, thereby causing the machine and/or computer to perform the steps as described herein for specifying timestamp properties for object marking and protocol exchange. method and system for security certificate properties for protocol exchange

Accordingly, aspects of the invention may be realized in hardware, software, firmware or a combination thereof. The invention may be realized in a centralized fashion in at least one computer system or in a distributed fashion where different elements are spread across several interconnected computer systems. Any kind of computer system or other apparatus adapted for carrying out the methods described herein is suited. A typical combination of hardware, software and firmware may be a general-purpose computer system with a computer program that, when being loaded and executed, controls the computer system such that it carries out the methods described herein.

One embodiment of the present invention may be implemented as a board level product, as a single chip, application specific integrated circuit (ASIC), or with varying levels integrated on a single chip with other portions of the system as separate components. The degree of integration of the system will primarily be determined by speed and cost considerations. Because of the sophisticated nature of modern processors, it is possible to utilize a commercially available processor, which may be implemented external to an ASIC implementation of the present system. Alternatively, if the processor is available as an ASIC core or logic block, then the commercially available processor may be implemented as part of an ASIC device with various functions implemented as firmware.

The present invention may also be embedded in a computer program product, which comprises all the features enabling the implementation of the methods described herein, and which when loaded in a computer system is able to carry out these methods. Computer program in the present context may mean, for example, any expression, in any language, code or notation, of a set of instructions intended to cause a system having an information processing capability to perform a particular function either directly or after either or both of the following: a) conversion to another language, code or notation; b) reproduction in a different material form. However, other meanings of computer program within the understanding of those skilled in the art are also contemplated by the present invention.

While the invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiments disclosed, but that the present invention will include all embodiments falling within the scope of the appended claims.

What is claimed is:

1. A method for communication, the method comprising:
securing exchange of multimedia information between two or more devices that communicate using media transfer protocol, wherein one or more keys and/or one or more security certificates are communicated between said two or more devices utilizing one or more objects specified by an extension of said media transfer protocol.

2. The method according to claim 1, comprising identifying an object as comprising said one or more security certificates based on a corresponding MTP object property.

3. The method according to claim 2, comprising indicating a source of said security certificate within an MTP object property.

4. The method according to claim 1, comprising identifying an object as comprising said one or more keys based on a corresponding MTP object property.

5. The method according to claim 4, comprising indicating a source of said key within an MTP object property.

6. The method according to claim 1, wherein said one of said two or more devices communicates said one or more objects and/or one or more object properties corresponding to said one or more objects to another of said two or more devices when said one of said two or more devices initiates communication with said another of said two or more devices.

7. The method according to claim 1, comprising specifying information about said one or more objects in response to a request.

8. The method according to claim 7, wherein said request comprises an MTP GetObjectPropDesc operation.

9. The method according to claim 7, wherein said response comprises an MTP ObjectPropDesc dataset.

10. The method according to claim 7, wherein said request comprises a GetObjectPropValue operation.

11. The method according to claim 7, wherein said response comprises data from a current value field of an MTP ObjectPropDesc dataset.

12. The method according to claim 1, comprising securing said MTP communication based on one or more MTP object properties.

13. A system for communication, the system comprising: one or more processors that secure exchange of multimedia information between two or more devices that communicate using media transfer protocol, wherein one or more keys and/or one or more security certificates are communicated between said two or more devices utilizing one or more objects specified by an extension of said media transfer protocol.

14. The system according to claim 13, wherein said one or more processors enables identification of an object as comprising said one or more security certificates based on a corresponding MTP object property.

15. The system according to claim 14, wherein said one or more processors enables indication of a source of said security certificate within an MTP object property.

16. The system according to claim 13, wherein said one or more processors enables identifying an object as comprising said one or more keys based on a corresponding MTP object property.

17. The system according to claim 16, wherein said one or more processors enables indicating a source of said key within an MTP object property.

18. The system according to claim 13, wherein said one of said two or more devices communicates said one or more objects and/or one or more object properties corresponding to said one or more objects to another of said two or more devices when said one of said two or more devices initiates communication with said another of said two or more devices.

19. The system according to claim 13, wherein said one or more processors enables specification of said information about said one or more objects in response to a request.

20. The system according to claim 19, wherein said request comprises an MTP GetObjectPropDesc operation.

21. The system according to claim 19, wherein said response comprises an MTP ObjectPropDesc dataset.

22. The system according to claim 19, wherein said request comprises a GetObjectPropValue operation.

23. The system according to claim 19, wherein said response comprises data from a current value field of an MTP ObjectPropDesc dataset.

24. The system according to claim 13, wherein said one or more processors enables securing said MTP communication based on one or more MTP object properties.

25. A machine-readable storage having stored thereon, a computer program having at least one code section for handling multimedia information, the at least one code section being executable by a machine for causing the machine to perform steps comprising:
securing exchange of multimedia information between two or more devices that communicate using media transfer protocol, wherein one or more keys and/or one or more security certificates are communicated between said two or more devices utilizing one or more objects specified by an extension of said media transfer protocol.

26. The machine-readable storage according to claim 25, wherein said at least one code section comprises code for identifying an object as comprising said one or more security certificates based on a corresponding MTP object property.

27. The machine-readable storage according to claim 26, wherein said at least one code section comprises code for indicating a source of said security certificate within an MTP object property.

28. The machine-readable storage according to claim 25, wherein said at least one code section comprises code for identifying an object as comprising said one or more keys based on a corresponding MTP object property.

29. The machine-readable storage according to claim 28, wherein said at least one code section comprises code for indicating a source of said key within an MTP object property.

30. The machine-readable storage according to claim 25, wherein said one of said two or more devices communicates said one or more objects and/or one or more object properties corresponding to said one or more objects to another of said two or more devices when said one of said two or more devices initiates communication with said another of said two or more devices.

31. The machine-readable storage according to claim 25, wherein said at least one code section comprises code for specifying said information about said one or more objects in response to a request.

32. The machine-readable storage according to claim 31, wherein said request comprises an MTP GetObjectPropDesc operation.

33. The machine-readable storage according to claim 31, wherein said response comprises an MTP ObjectPropDesc dataset.

34. The machine-readable storage according to claim 31, wherein said request comprises a GetObjectPropValue operation.

35. The machine-readable storage according to claim 31, wherein said response comprises data from a current value field of an MTP ObjectPropDesc dataset.

36. The machine-readable storage according to claim 25, wherein said at least one code section comprises code for securing said MTP communication based on one or more MTP object properties.
